(19) United States
(12) Patent Application Publication
(10) Pub. No.: US 2025/0227404 A1
(43) Pub. Date: Jul. 10, 2025

(54) EARPIECE

(71) Applicant: Fumihiko KANEKO, Tokyo (JP)

(72) Inventor: Fumihiko KANEKO, Tokyo (JP)

(21) Appl. No.: 18/853,225

(22) PCT Filed: Feb. 28, 2023
(86) PCT No.: PCT/JP2023/007179

§ 371 Date: Oct. 1, 2024

(30) Foreign Application Priority Data
Jun. 6, 2022 (JP) 2022-099915

(51) Int. Cl. H04R 1/10

(52) U.S. Cl. CPC H04R 1/1016

(57) ABSTRACT

The present invention provides an earpiece having a comfort performance and a tight-closing performance. By disposing an air-releasing hole 47 or an air-releasing recess 48 to a stiffness-supporting member 6, a gas 44 within a range surrounded by an axis member 1, an umbrella member 2, and a stiffness-supporting member 6 are always opened to avoid occurrence of a concave deformation 42 and to avoid degradation of a deformation following-up performance of the umbrella member 2. By making the umbrella member 2, the axis member 1, and the stiffness-supporting member 6 are formed from different materials, the comfort performance, the tight-closing performance and contacting force with the audio-signal output device 13 can be improved when wearing the earpiece. By disposing an indent or a material range being easily deformed to the axis member between the umbrella member 2 and the stiffness-supporting member 6, the earpiece, of which axis center 55 and the axis center 56 can be deformed to a position forming an obtuse angle, is provided so as to be inserted easily into an ear canal 33 having a complex shape. By making colors of the umbrella member 2 and the stiffness-supporting member 6 different, the stiffness-supporting member 6 can become easily recognized.

### TECHNICAL FIELD

The present invention relates to an ear chip, an ear-chip, an earpiece, and an ear-piece.

### BACKGROUND TECHNOLOGY

In Patent Literature 1, an earpiece, which can close tightly an ear canal by providing a stiffness-supporting member for suppressing the deformation of umbrella member to a right-angled direction from an axis-member core, has been disclosed.

### PRIOR ART LITERATURE

### Patent Literature

Patent Literature 1 JP2022-083362

### SUMMARY OF INVENTION

### Problem to be Solved by Invention

Under the condition where the inside of ear canal 33 is closed tightly by the earpiece of Patent Literature 1, for removing the earpiece from the ear canal 33 and applying an action force 49 to an audio-signal output device 13, the air in the ear canal 33 between the umbrella member 2 and an ear drum 35 becomes negative pressure such that a reaction force 50 against the action force 49 can be generated.

In the condition where the contact force 51 between the audio-signal output device and the earpiece is lower than the reaction force 50, when the action force 49 is applied to the audio-signal output device for removing the earpiece from the ear canal 33, the audio-signal output device 13 and the earpiece might be separated.

When the audio-signal output device 13 and the earpiece is separated, the problems should occur that only the earpiece is left alone in the ear canal 33 or that the earpiece falls down.

Because functions required for each position are different, if the umbrella member 2 and the stiffness-supporting member 6 are made from the same material, it becomes difficult for the earpiece to balance a stable and tight-closing performance in the ear canal 33 and a comfort performance when putting-on.

When the earpiece of Patent Literature 1 is inserted into the ear canal 33, there may be the case that the umbrella member 2 forms a concave deformation 42 by receiving the pressure 41 from the inner wall of ear canal.

When a clearance 43 between the umbrella member and the stiffness-supporting member is closed, the air 44 in the range surrounded by the axial member, the umbrella member and the stiffness-supporting member is cut off from the outside air to generate the condition of trapped air 45.

Since the volume of air 45 trapped by the axial member, the umbrella member and the stiffness-supporting member becomes difficult to change such that the umbrella member 2 becomes difficult to be deformed by the action force 46 due to the air pressure from the outside.

In the condition where the concave deformation 42 is occurring in the umbrella member 2 and when the clearance 43 between the umbrella member and the stiffness-supporting member is closed, the umbrella member 2 keeps the condition of the concave-deformation 42 due to the action force 46 of the air pressure from the outside.

With respect to the umbrella member 2 to which the concave deformation 42 hardly deformed is kept, a clearance 23 becomes easily formed between the inner wall 34 of ear canal such that it become difficult to close tightly the inside of ear canal 33.

The ear canal 33 has a non-symmetric shape being formed by a plurality of complex curves, and a conventional earpiece has a symmetric shape with a round body.

The earpiece of symmetric shape becomes difficult to conform with the shape of the ear canal 33 having the non-symmetric shape such that clearances become easily formed between the umbrella member 2 and the inner wall 34 of ear canal.

When the tightly-closed condition cannot be obtained in the ear canal 33 due to the formation of clearance between the umbrella member 2 and the inner wall 34 of ear canal, the sound effect and the quality of audio-signal output device 13 become difficult to exhibit.

Since the stiffness-supporting member 6 is a small part positioned inside the umbrella member 2, the presence thereof is difficult to be recognized.

The present invention aims to improve a contact performance between the audio-signal output device 13 and the earpiece, a stable and tight-closing performance in the ear canal 33, and a comfort performance when putting-on as well as improving the visible performance of stiffness-supporting member.

### Means for Solving Problem

By making the material of axial member 1 stiffer than the material of umbrella member 2, the contact force 51 between the audio-signal output device 13 and the earpiece becomes improved.

By making the stiffness-supporting member 6 different from the material of umbrella member 2, the stiffness-supporting performance to the umbrella member 2 by the stiffness-supporting member 6 can be adjusted such that the stable and tight-closing performance in the ear canal 33 by the earpiece and the comfort performance when putting-on can be improved.

An aperture such as an air-releasing hole 47 or an air-releasing recess 48 etc. to the stiffness-supporting member 6 is formed so as to always open the air 44 in the range surrounded by the axis member 1, the umbrella member 2, and the stiffness-supporting member 6; an effect by the action force 46 with the air pressure to the umbrella member 2 from the outside is suppressed: and the state is avoided where the umbrella member 2 becomes hardly deformed or the continuation of state being kept at the concave deformation 42.

To the axial member 1 between the umbrella member 2 and the stiffness-supporting member 6, an indent 53 or an easily-bendable part, which is made from an easily-bendable material at a range 54, is disposed.

By disposing the easily-bendable part to the axis member 1 between the umbrella member 2 and the stiffness-supporting member 6, the earpiece can be deformed to the position where the axis center 55 of umbrella member 2 and the axis center 56 of axis member 1 at the audio-signal output device side form an obtuse angle.

The earpiece is deformed to the position where the axis center 55 of umbrella member 2 and the axis center 56 of axis member 1 at the audio-signal output device side form the obtuse angle such that it becomes easier to conform with the non-symmetric and the curved shape of ear canal.

The earpiece becomes easier to conform with the non-symmetric and the curved shape of ear canal such that the tight-closing performance in the ear canal 33 by the umbrella member 2 may be improved.

At the outer periphery of stiffness-supporting member 6, the member 61, which has a shape being accommodated to the trajectory of deformation for the umbrella member, is disposed.

By disposing the member 61, which has the shape being accommodated to the trajectory of the deformation for the umbrella member, to the outer periphery of stiffness-supporting member 6, the stiffness-supporting to the umbrella member 2 under the deformation of earpiece becomes stable such that the tight-closing performance in the ear canal 33 becomes stable.

When the inner wall 34 of ear canal receives loads due to strong rubbing between the inner wall 34 of ear canal and the outer surface 58 of umbrella member, the comfort performance becomes lower when the earpiece is putting-on.

Materials and surface conditions for the umbrella member and the stiffness-supporting member are selected such that the force being generated when the inner surface 57 of umbrella member and the surface 62 of stiffness-supporting member are rubbed becomes lower than the force generated when the inner wall 34 of ear canal and the outer surface 58 of umbrella member are rubbed.

When the action force 59 is applied externally to the audio-signal output device 13, the gap is generated between the inner surface 57 of umbrella member at which the generated force under rubbed is lower and the surface 62 of stiffness-supporting member.

Due to the generation of gap between the inner surface 57 of umbrella member and the surface 62 of stiffness-supporting member, the strength of force transferred from the action force 59 to the inner wall 34 of ear canal becomes lower.

The stiffness-supporting member 6 is selected to have a different color from the umbrella member 2.

### ADVANTAGEOUS EFFECT OF INVENTION

The material of axis member 1 is selected as a stronger material than that of the umbrella member 2 to improve the contact force 51 between the audio-signal output device 13 and the earpiece such that the problem, that the audio-signal output device 13 and the earpiece becomes separated to leave the earpiece in the ear canal 33 or that the earpiece falls down, may be avoided.

By selecting the material of stiffness-supporting member 6 being different from the umbrella member 2 suitable to stiffness supporting, the stable and tight-closing performance by the umbrella member 2 in the ear canal 33 and the comfort performance when putting-on can be improved.

The stiffness-supporting member 6 is formed with an air-releasing hole 47 or an air-releasing recess 48, and the air 44 in the range surrounded by the axis member 1, the umbrella member 2 and the stiffness-supporting member 6 is made always opened such that the umbrella member 2 is prevented from the state being hardly deformed and the state of concave deformation 42 so as to make the tight-closing performance of ear canal 33 by the umbrella member 2 stable.

The earpiece is deformed to the position where the axis center 55 of umbrella member 2 and the axis center 56 of axis member 1 at the audio-signal output device side form an obtuse angle and it becomes easy to conform with the curved shape of asymmetric ear canal 33 such that the tight-closing performance of ear canal 33 by the umbrella member 2 may be improved.

Due to the gap generated between the inner surface 57 of umbrella member and the surface 62 of stiffness-supporting member, the strength of force transferred from the action force 59 to the umbrella member becomes lower such that the position of umbrella member 2 in the ear canal 33 becomes stable and the load to the inner wall 34 of ear canal from the outer surface 58 of umbrella member becomes lower, and thus the comfort performance when putting on the earpiece becomes improved.

With the improved tight-closing performance by the earpiece, the sound effects and the qualities of audio-signal output device 13 can be obtained.

With improving the comfort performance and the stability when the earpiece is put on, it becomes easier to put on the earpiece for long periods of time.

The stiffness-supporting member 6, which becomes easy to be recognized by adopting the different color from the umbrella member 2, can be a marker for the putting-on procedure of earpiece.

The material of earpiece according to the present invention is not limited so far as it has elasticity.

### BRIEF DESCRIPTION OF DRAWINGS

FIG. 1 is a schematical side cross-sectional view of the state where the air in an ear canal 33 between an umbrella member 2 and an ear drum 35 becomes negative pressure such that a reaction force 50 is generated against the action force 49 that pulls outside an audio-signal output device 13 is generated.

FIG. 2 is a schematical side cross-sectional view of the state where an audio-signal output device 13 and the earpiece has been separated and only the earpiece is left in the ear canal 33.

FIG. 3 is a schematical side cross-sectional view of the state where an audio-signal output device 13 and the earpiece has been separated and then the earpiece falls down.

FIG. 4 is a schematical side cross-sectional view of the umbrella member 2 to which a concave deformation 42 is formed by receiving pressure 41 from the inner wall 34 of ear canal.

FIG. 5a shows a schematical side cross-sectional view of the states where a clearance 43 between an umbrella member 2 and a stiffness-supporting member 6 is closed and the air 44 in the range surrounded by an axial member 1, an umbrella member 2, and a stiffness-supporting member 6 becomes trapped air 45.

FIG. 5b shows another schematical side cross-sectional view of the states where a clearance 43 between an umbrella member 2 and a stiffness-supporting member 6 is closed and the air 44 in the range surrounded by an axial member 1, an umbrella member 2, and a stiffness-supporting member 6 becomes trapped air 45.

FIG. 6a shows a schematical side cross-sectional view of the umbrella member 2 which keeps a concave deformation 42 by an action force 46 from the outside air pressure.

FIG. 6b shows another schematical side cross-sectional view of the umbrella member 2 which keeps a concave deformation 42 by an action force 46 from the outside air pressure.

FIG. 7 is a schematical side cross-sectional view of a clearance 23 between an umbrella member 2 and the inner wall 34 of ear canal when a concave deformation 42 is generated.

FIG. 8a shows a schematic side cross-sectional view of the states where a stiffness-supporting member 6 is hindered inside an umbrella member 2.

FIG. 8b shows a schematical side view of the states where a stiffness-supporting member 6 is hindered inside an umbrella member 2.

FIG. 9 is a schematical side cross-sectional view where an axial member 1 is made from the material different from an umbrella member 2 for making an earpiece hardly separated from an audio-signal output device 13.

FIG. 10 is a schematical side cross-sectional view where a stiffness-supporting member 6 is made from the material different from an umbrella member 2 for improving a stable tight-closing performance and a comfort performance in an ear canal 33 by the umbrella member 2.

FIG. 11 is a schematical side cross-sectional view of the state where the air 44 in a range surrounded by an axial member, an umbrella member, and a stiffness-supporting member is always opened by an air-releasing hole 47 or an air-releasing recess 48 disposed to a stiffness-supporting member 6.

FIG. 12 is a schematical C-C cross-sectional view showing the state where the air 44 in a range surrounded by an axial member, an umbrella member, and a stiffness-supporting member is always opened by an air-releasing hole 47 or an air-releasing recess 48 disposed to a stiffness-supporting member 6.

FIG. 13a shows a schematical side cross-sectional view showing the earpiece of which an axial member 1 is bent about an indent 53 disposed to the axial member 1 between an umbrella member 2 and a stiffness-supporting member 6 and is deformed to the position where the axis center 55 of umbrella member 2 and the axis center 56 of axis member 1 at an audio-signal output device side form an obtuse angle.

FIG. 13b shows another schematical side cross-sectional view showing the earpiece of which an axial member 1 is bent about an indent 53 disposed to the axial member 1 between an umbrella member 2 and a stiffness-supporting member 6 and is deformed to the position where the axis center 55 of umbrella member 2 and the axis center 56 of axis member 1 at an audio-signal output device side form an obtuse angle.

FIG. 14a shows a schematical side cross-sectional view showing the earpiece of which an axial member 1 is bent about the range of material deformable easily disposed to an axis part 1 between an umbrella member 2 and a stiffness-supporting member 6 and is deformed to the position where the axis center 55 of umbrella member 2 and the axis center 56 of axis member 1 at an audio-signal output device side form an obtuse angle.

FIG. 14b shows another schematical side cross-sectional view showing the earpiece of which an axial member 1 is bent about the range of material deformable easily disposed to an axis part 1 between an umbrella member 2 and a stiffness-supporting member 6 and is deformed to the position where the axis center 55 of umbrella member 2 and the axis center 56 of axis member 1 at an audio-signal output device side form an obtuse angle.

FIG. 15a shows a schematical side cross-sectional view showing the earpiece of which an axial member 1 is bent about an indent within the range of material deformable easily disposed to an axis member 1 between an umbrella member 2 and a stiffness-supporting member 6 and is deformed to the position where the axis center 55 of umbrella member 2 and the axis center 56 of axis member 1 at an audio-signal output device side form an obtuse angle.

FIG. 15b shows another schematical side cross-sectional view showing the earpiece of which an axial member 1 is bent about an indent within the range of material deformable easily disposed to an axis member 1 between an umbrella member 2 and a stiffness-supporting member 6 and is deformed to the position where the axis center 55 of umbrella member 2 and the axis center 56 of axis member 1 at an audio-signal output device side form an obtuse angle.

FIG. 16a is a schematical side cross-sectional view showing the states where an umbrella member 2 receives stable stiffness supporting by a member 61 and is deformed stably and smoothly to the position where the axis center 55 of umbrella member 2 and the axis center 56 of axis member 1 at an audio-signal output device side form an obtuse angle.

FIG. 16b is another schematical side cross-sectional view showing the states where an umbrella member 2 receives stable stiffness supporting by a member 61 and is deformed stably and smoothly to the position where the axis center 55 of umbrella member 2 and the axis center 56 of axis member 1 at an audio-signal output device side form an obtuse angle.

FIG. 17a shows a schematical side cross-sectional view showing the states where a gap between the umbrella member and the stiffness-supporting member is generated by the action force 59 to the audio-signal output device 13 under the condition where the earpiece, of which force generated when the surface of umbrella member and the surface of stiffness-supporting member are rubbed is smaller than the force generated when the inner face of ear canal and the face of umbrella member are rubbed, is inserted to the ear canal 33.

FIG. 17b shows another schematical side cross-sectional view showing the states where a gap between the umbrella member and the stiffness-supporting member is generated by the action force 59 to the audio-signal output device 13 under the condition where the earpiece, of which force generated when the surface of umbrella member and the surface of stiffness-supporting member are rubbed is smaller than the force generated when the inner face of ear canal and the face of umbrella member are rubbed, is inserted to the ear canal 33.

FIG. 18 shows a schematical side cross-sectional view in which the stiffness-supporting member 6 and the member 61 are made from a viscoelastic material body 63.

FIG. 19a shows a schematical side cross-sectional view of the states where the umbrella member and the stiffness-supporting member have the same color and the state where those have different colors.

FIG. 19b shows another schematical side cross-sectional view of the states where the umbrella member and the stiffness-supporting member have the same color and the state where those have different colors.

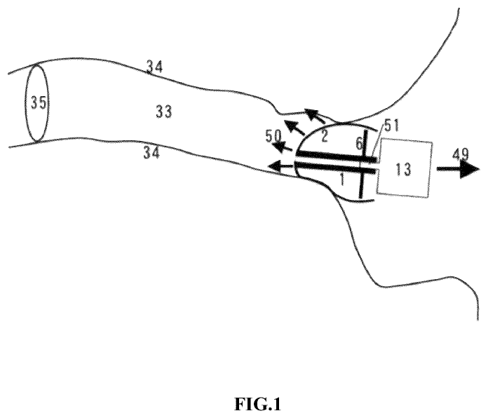

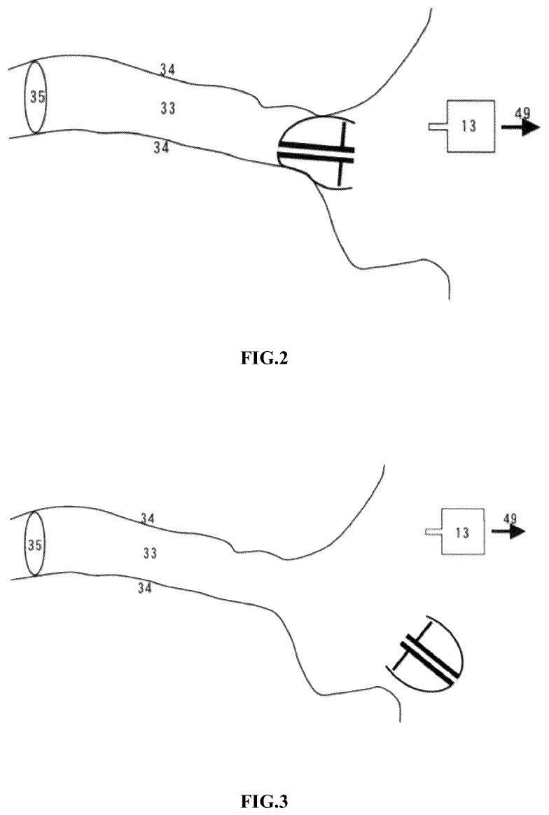

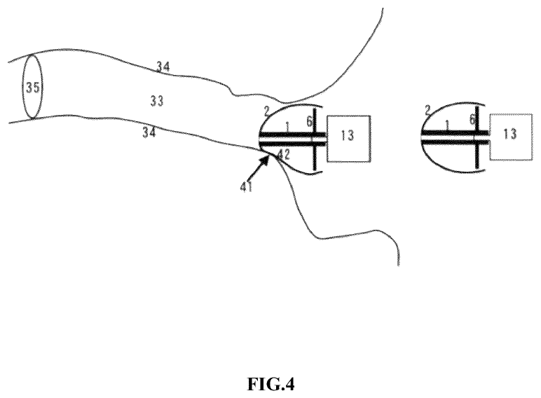

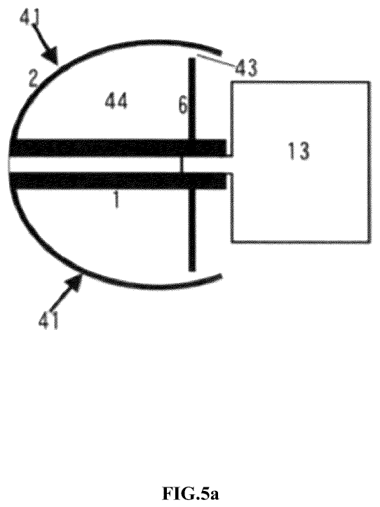

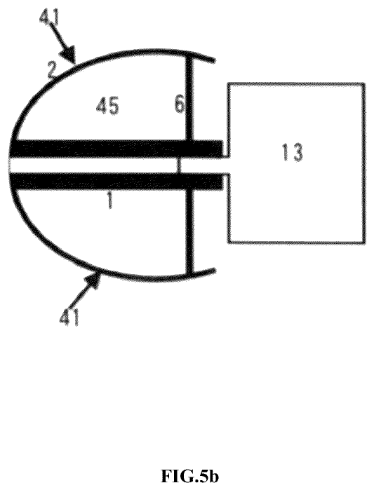

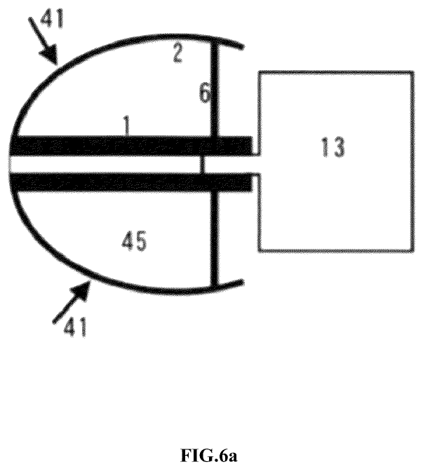

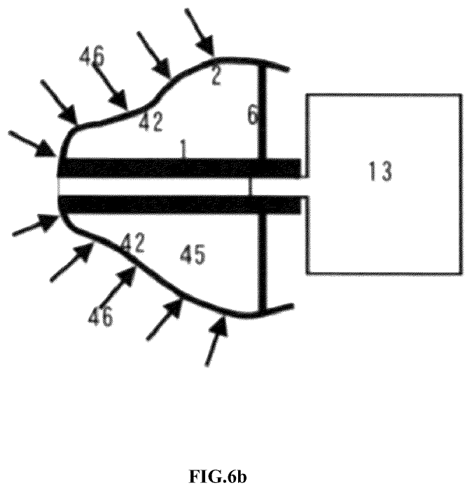

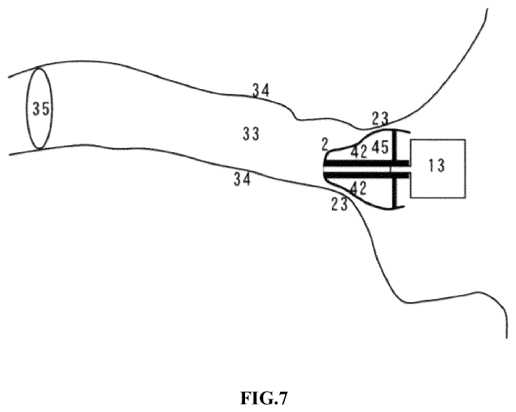

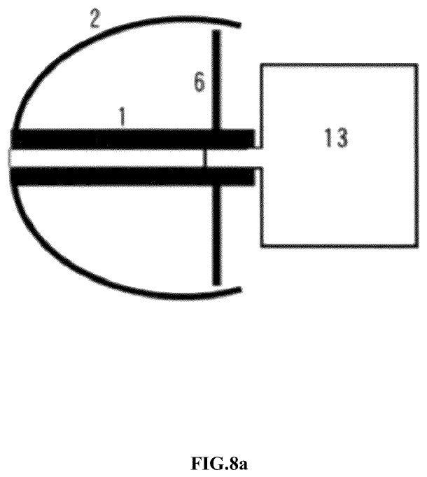

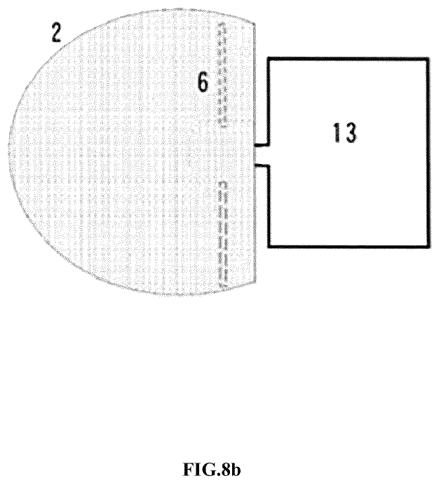

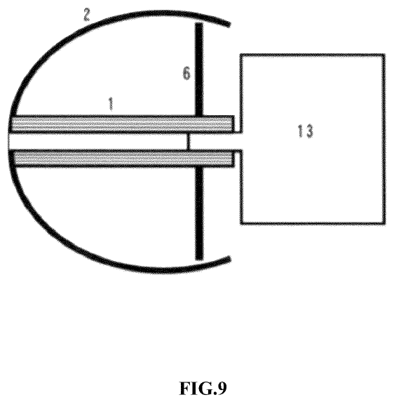

### EMBODIMENT FOR PRACTICING INVENTION

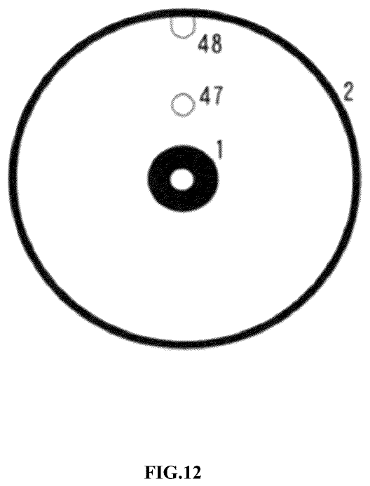

In FIG. 11 and FIG. 12, examples are shown to which an air-releasing hole 47 and an air-releasing recess 48 are disposed to a stiffness-supporting member 6.

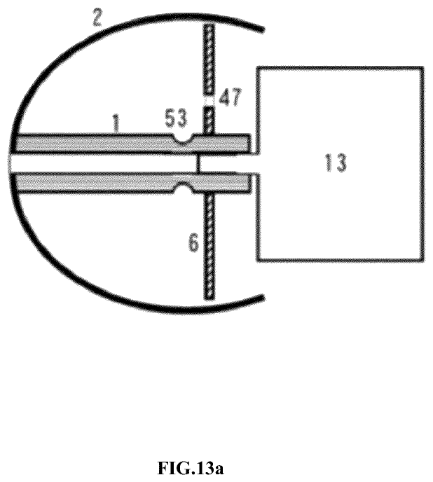

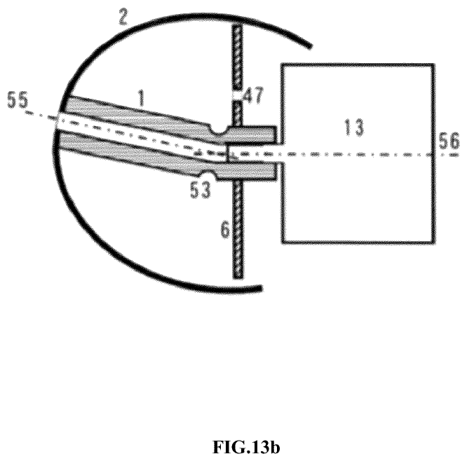

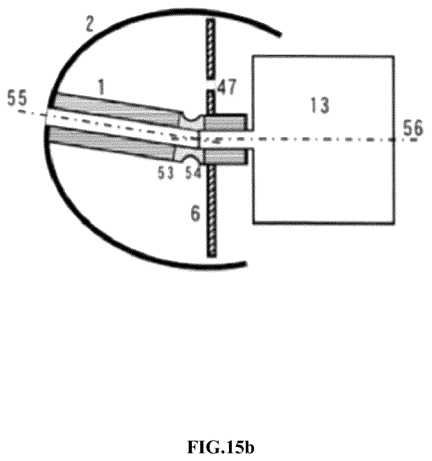

In FIG. 13-17, examples are shown to which the air-releasing hole 47 are disposed to the stiffness-supporting member 6.

In FIG. 9, an example of which materials for the umbrella member 2 and the axis member 1 are made from different materials.

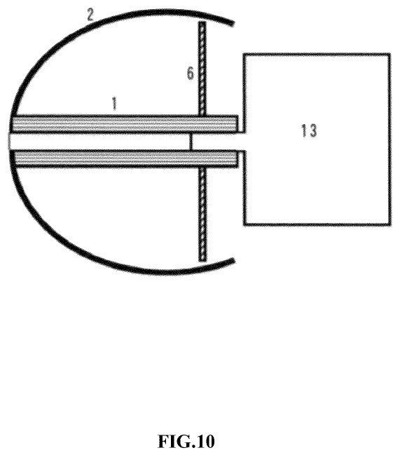

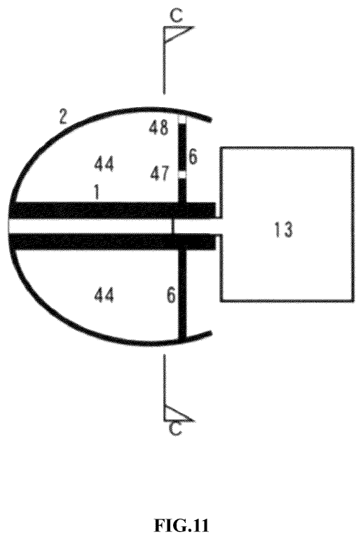

In FIG. 10, an example of which materials for the umbrella member 2 and the stiffness-supporting member 6 are made from different materials.

In FIG. 13, an example is shown to which an indent 53 is disposed to an axis member 1 between the umbrella member 2 and the stiffness-supporting member 6 to make the axis member 1 easy to be bent.

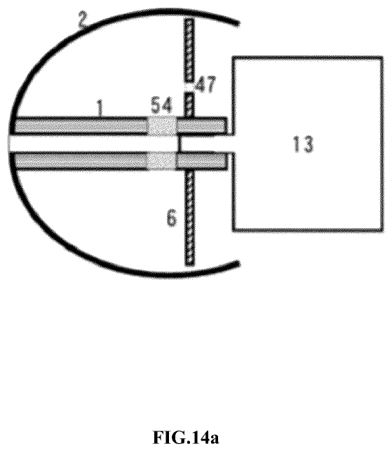

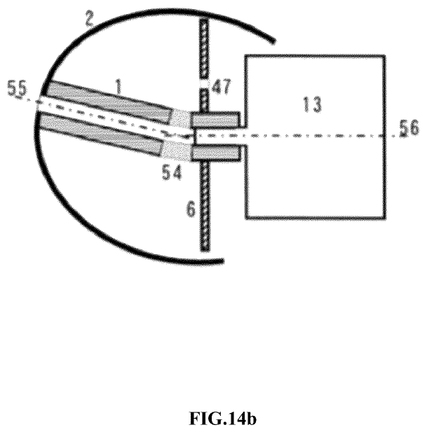

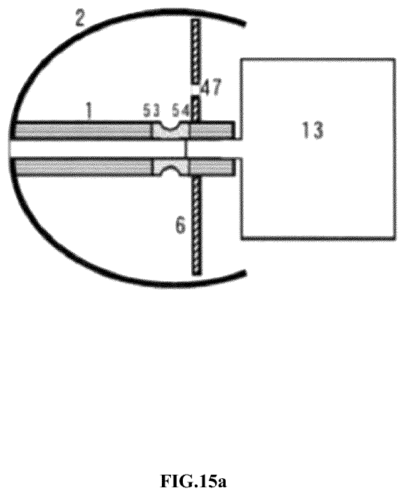

In FIG. 14, an example is shown to which the range being easy to be bent 54 is disposed to the axis member 1 between the umbrella member 2 and the stiffness-supporting member 6 to make the axis member 1 easy to be bent.

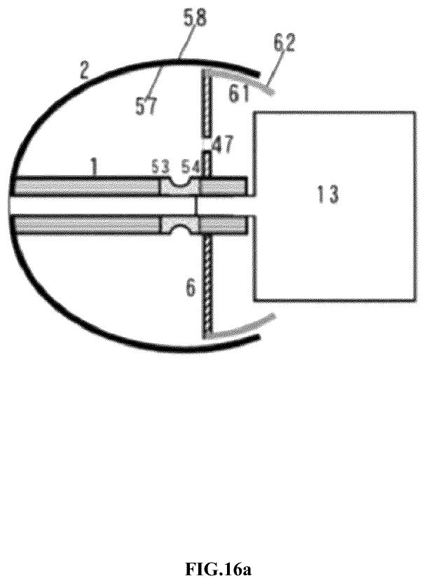

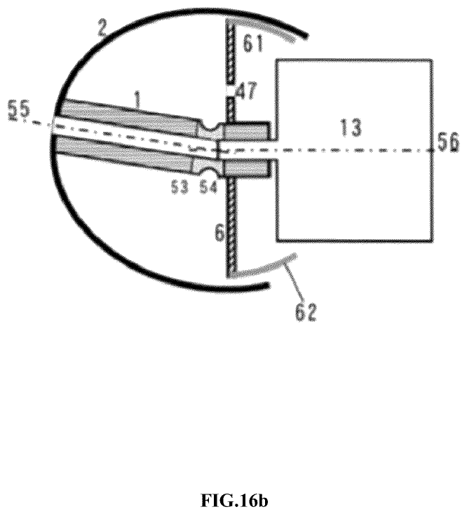

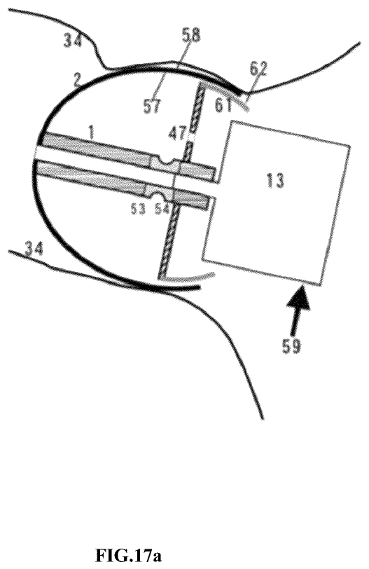

In FIG. 16, an example is shown to which the member 61, which has the shape conforming to the displacement trajectory of umbrella member, is disposed to the outer periphery of stiffness-supporting member 6.

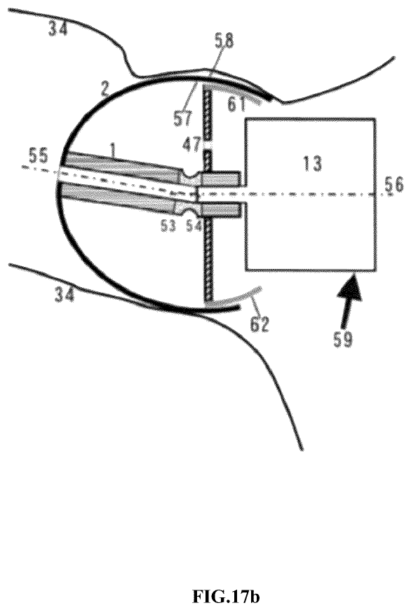

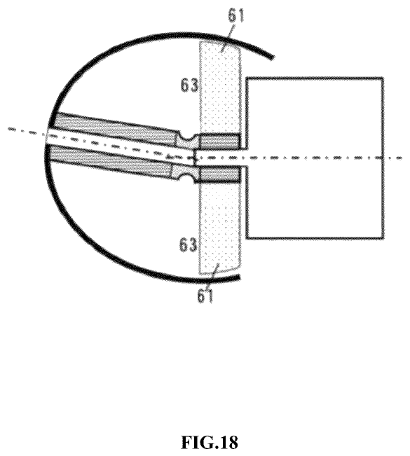

In FIG. 17, the modified example of earpiece is shown, in which the force generated when the inner face 34 of ear canal and the outer face 58 of umbrella member are rubbed is made smaller than the force generated when the surface 57 of umbrella member and the surface 62 of stiffness-supporting member are rubbed.

In FIG. 18, an example in which the material of stiffness-supporting member is made from the viscoelastic body 63.

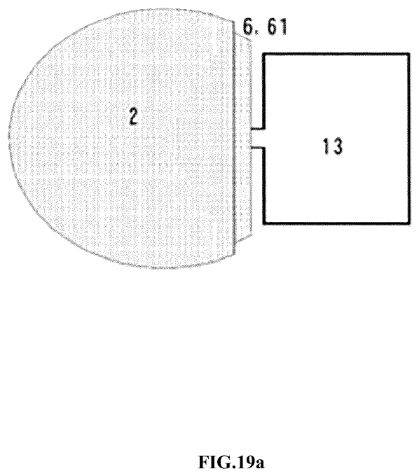

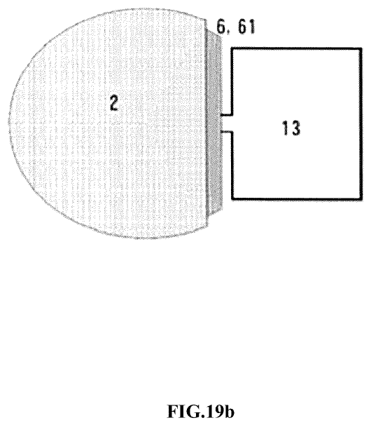

In FIG. 19, the umbrella member 2, the stiffness-supporting member 6, and the member 61 have the different colors.

As described above, contents described about the embodiment according to the present invention should not limit the invention relating to the scope of the claimed invention.

### DESCRIPTION OF NUMERALS

1 axis member
2 umbrella member
6 stiffness-supporting member suppressing deformation of umbrella member 2 from inside and being connected to axis member 1
13 audio-signal output device
23 clearance between umbrella member 2 and inner wall 34 of ear canal
33 ear canal
34 inner wall of ear canal 33
35 ear drum
41 pressure from inner wall 34 of ear canal
42 concave deformation generated to umbrella member 2
43 clearance between umbrella member 2 and stiffness-supporting member 6
44 air surrounded by axis member 1, umbrella member 2, and stiffness-supporting member 6
45 air trapped by axis member 1, umbrella member 2, and stiffness-supporting member 6
46 action force 46 to umbrella member 2 by air pressure from outside
47 air-releasing hole disposed to stiffness-supporting member
48 air-releasing recess disposed to stiffness-supporting member
49 force applied to audio-signal output device 13 for removing earpiece from inside of ear canal 33
50 reaction force generated as result of becoming negative pressure of air inside ear canal 33 between umbrella member 2 and ear drum 35
51 contact force between audio-signal output device and earpiece
53 indent disposed to axis member 1 between umbrella member 2 and stiffness-supporting member 6
54 region of material being easily deformed disposed to axis member 1 between umbrella member 2 and stiffness-supporting member 6
55 axis center of umbrella member 2
56 axis center of axis member 1 at audio-signal output device side
57 inner surface of umbrella member
58 outer surface of umbrella member
59 force acting to audio-signal output device 13 form outside
61 member having shape conforming to deformation trajectory of umbrella member 2 and being disposed to outer periphery of stiffness-supporting member 6
62 member having shape conforming to deformation trajectory of umbrella member 2 and being disposed to outer periphery of stiffness-supporting member 6
63 stiffness-supporting member made from viscoelastic material

1. An earpiece having a stiffness-supporting member for suppressing deformation of an umbrella member toward a right-angled direction of an axis-member core from an inside of the umbrella member, wherein the umbrella member and the axis member are made from different materials.

2. The earpiece having a stiffness-supporting member for suppressing deformation of an umbrella member toward a right-angled direction of an axis-member core from an inside of the umbrella member as claimed in claim 1, wherein the umbrella member and the stiffness-supporting member are made from different materials.

3. The earpiece having a stiffness-supporting member for suppressing deformation of an umbrella member toward a right-angled direction of an axis-member core from an inside of the umbrella member as claimed in claim 1, wherein a hole, a recess, or an aperture is disposed to the stiffness-supporting member.

4. The earpiece having a stiffness-supporting member for suppressing deformation of an umbrella member toward a right-angled direction of an axis-member core from an inside of the umbrella member as claimed in claim 1, wherein an indent is disposed to an axis member between the umbrella member and the stiffness-supporting member to make the axis member easy to be deformed.

5. The earpiece having a stiffness-supporting member for suppressing deformation of an umbrella member toward a right-angled direction of an axis member from an inside of the umbrella member as claimed in claim 1, wherein a range of a material being different from a range connecting with an audio-signal output device is disposed between the umbrella member and the stiffness-supporting member.

6. The earpiece having a stiffness-supporting member for suppressing deformation of an umbrella member toward a right-angled direction of an axis-member core from an inside of the umbrella member as claimed in claim 1, wherein a shaped part, being conformed with a displacement trajectory of the umbrella member, is disposed to the stiffness-supporting member.

7. The earpiece having a stiffness-supporting member for suppressing deformation of an umbrella member toward a right-angled direction of an axis-member core from an inside of the umbrella member as claimed in claim 1, wherein force generated when a face of the umbrella member and a face of the stiffness-supporting member are rubbed is smaller than force generated when an inner wall face of an ear canal and the face of the umbrella member are rubbed.

8. The earpiece having a stiffness-supporting member for suppressing deformation of an umbrella member toward a right-angled direction of an axis-member core from an inside of the umbrella member as claimed in claim 1, wherein colors of the umbrella member and the stiffness-supporting member are different.
